(19) United States
(12) Patent Application Publication
(10) Pub. No.: US 2015/0159790 A1
(43) Pub. Date: Jun. 11, 2015

(54) Jet Pump Slip Joint Seal

(71) Applicant: AREVA Inc., Lynchburg, VA (US)

(72) Inventor: Kenneth Wade Markham, Forest, VA (US)

(21) Appl. No.: 14/559,626

(22) Filed: Dec. 3, 2014

Related U.S. Application Data
(60) Provisional application No. 61/912,221, filed on Dec. 5, 2013.

(51) Int. Cl. F16L 21/06

(52) U.S. Cl. CPC F16L 21/06

(57) ABSTRACT

A seal collar is disclosed and claimed. The seal is provided in two hinged parts that wrap around the piping to be sealed. The seal halves are connected to form a loop. The seal components may be formed of a shape memory alloy. Once the seal is properly positioned about the pipe, heat is applied to shrink the seal to provide a tight, sealing fit about the pipe. Alternatively, the clamp is formed of stainless steel and a bolt is used to secure the clamp halves to the mixer assembly.

### CROSS-REFERENCE TO RELATED APPLICATIONS

This patent application claims the benefit of U.S. Provisional Patent Application No. 61/912,221 filed on Dec. 5, 2013, which is incorporated herein by reference in its entirety.

### BACKGROUND OF THE INVENTION

1. Field of the Invention

The present invention relates to a clamp, and, more particularly, the present invention relates to a repair device for use, for example, with boiling water reactor jet pumps.

2. Description of the Related Art

While the present invention may be used in a variety of industries, the environment of a boiling water reactor (BWR) nuclear power plant will be discussed herein for illustrative purposes. In a BWR, a steam-water mixture is produced when reactor coolant (water) moves upward through the core, absorbing heat produced by the fuel. The steam-water mixture leaves the top of the core and enters a moisture separator, where water droplets are removed before the steam is allowed to enter the steam line. The steam line directs the steam to the main turbine, causing it to turn the turbine and the attached electrical generator. The steam is then exhausted to a condenser where it is condensed into water. The resulting water is pumped out of the condenser back to the reactor vessel. Recirculation pumps and jet pumps allow the operator to vary coolant flow through the core and change reactor power.

Within the BWR vessel, a core shroud surrounds the core to provide a barrier to separate the downward coolant flow through the annulus/downcomer (the space between the core shroud and the reactor vessel wall) from the upward flow through the core and fuel bundles. In a typical boiling water reactor, jet pumps are located in the downcomer and provide forced flow of coolant through the reactor vessel in order to yield higher reactor power output than would be possible with natural circulation. Twenty jet pumps are located in two semicircular groups in the annular downcomer region of the reactor. Two jet pumps and a common inlet header or riser pipe comprise a jet pump assembly as shown in FIG. 1. Each jet pump assembly 1 includes an inlet riser pipe 2, a short radius elbow 3 welded at the bottom of the riser pipe 2, a transition piece 4 welded to the top of the riser pipe 2, two inlet mixer assemblies 5, and two conical diffuser assemblies 6.

FIG. 2 shows a typical inlet mixer assembly 5. Each inlet mixer assembly 5 includes an elbow 7 and associated converging nozzle 8, a flow mixing section 9, and a gravity wedge apparatus 10 that is employed in the lateral restraint of the inlet mixer 5.

Inlet risers 2 are utilized for each jet pump assembly 1 to permit the reactor recirculation inlet nozzles to be located below the active fuel region. This prevents significant fast neutron exposure which could adversely affect the mechanical properties of the nozzle penetration welds. Additionally, riser brace arms 11 provide lateral support for the upper end of the jet pump assembly 1 and also allow for the vertical differential expansion between the riser 2 and the reactor vessel during plant heat-up and cool-down.

The inlet mixer elbow 7 and converging nozzle 8 sections redirect the coolant flow stream 180° and increase the velocity of the flow stream as the coolant passes through the nozzle 8. This increase in fluid flow velocity results in lower static pressure of the driving flow. This decreased static pressure in the upper end of the inlet mixer 5 draws higher pressure water from the downcomer plenum and the two flows (driving and driven) are then combined together in the mixing section 9 of the inlet mixer 5. The inlet mixer 5 interfaces with the diffuser assembly 6 at the slip joint 12 of the jet pump. The slip joint 12 provides means to remove the inlet mixer assembly 5 from a jet pump assembly 1 and also accommodates the differential thermal expansion that occurs in the jet pump assembly 1 during plant heat-up and cool-down. This differential thermal expansion is the result of the riser pipe 2 being anchored in the low alloy carbon steel of the reactor vessel and the differing lengths of stainless steel jet pump components. The inlet mixer assemblies 5 are supported laterally by a restrainer bracket 13 that is welded to the riser pipe 2. The gravity wedge 10 of the inlet mixer and two opposing set screws that are mounted to the restrainer bracket 13 are designed to restrain the inlet mixer 5.

The inlet mixers 5 are subject to flow induced vibration resulting from the mixing action of the driving and driven flow components in the mixing section 9 of the inlet mixer 5. In addition, unstable pressure fluctuations result from the passage of coolant through the slip joint 12 to the lower pressure downcomer annulus. Consequently, abnormal wear of jet pump assembly 1 components has been experienced at several BWR plants. Components affected have been the inlet mixer 5 and diffuser collar 6 at the slip joint location 12, and the gravity wedge 10 and interfacing surface of the restrainer bracket 13. Isolated cracking has also been experienced at the set screw tack welds, riser brace 11 to riser pipe 2 weld, and short radius elbow 3 to thermal sleeve weld.

Attempts have been made to stop damage due to flow induced vibration. Such prior attempts include slip joint clamps and auxiliary spring wedge assemblies. Slip joint clamps act like a c-clamp to lock the mixer pipe to the diffuser. Auxiliary spring wedges work in place of a set screw that is no longer touching the jet pump mixer assembly. Some power plants have removed the mixer assemblies and machined grooves on the sealing surface in the slip joint to create a labyrinth seal. However, each of these attempts has proven to be ineffective at preventing damage to the jet pump assemblies.

Thus, there is a need to provide a simple mechanical device which will minimize or limit coolant leakage at the slip joint location and also provide supplemental structural support to the jet pump assembly.

### SUMMARY OF THE INVENTION

This invention is a seal collar that is hinged in two halves that wraps around the jet pump mixer assembly and sea n top of the diffuser collar assembly. In one embodiment, the clamp is formed of stainless steel and a bolted joint is used to secure the clamp halves to the mixer assembly. Alternatively, the clamp halves are connected to form a loop that is made out of a shape memory alloy, and when properly positioned are contracted onto the mixer assembly. The clamp may include notches that fit around the diffuser collar fins and have enough clearance to allow for the mixer to be offset from the diffuser. A flexure geometry is included in the design that will allow the diffuser o grow thermally without overstressing the clamp material.

For the shape memory alloy clamp, the seal components are curved to an initial shape that corresponds to the outer surface of the jet pump mixer. The seal components are then plastically deformed, such as by stretching, to increase the sizes thereof. The enlarged seal components are then positioned about the mixer and ends thereof are connected together to form a continuous loop about the mixer. The enlarged seal components have greater radii of curvature, providing clearance and facilitating positioning about the inlet mixer. Once in position about the mixer, the connected seal components are heated to return them to their original size, thereby clamping them to the jet pump mixer. The seal components are positioned adjacent the slip joint, and the clamping force imparted by the seal prevents jet pump vibration by restricting the flow path in the slip joint. The bottom edges of the seal components provide a seal with the jet pump diffuser.

### DESCRIPTION OF THE DRAWINGS

The present invention is described with reference to the accompanying drawings, which illustrate exemplary embodiments and in which like reference characters reference like elements. It is intended that the embodiments and figures disclosed herein are to be considered illustrative rather than restrictive.

FIG. 1 shows a typical jet pump assembly.

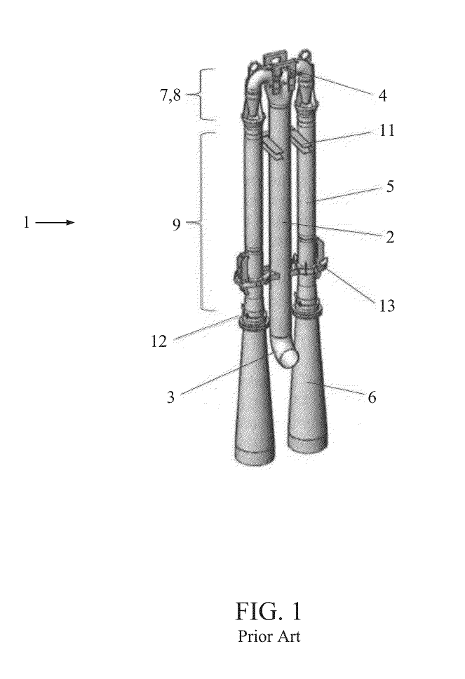

FIG. 2 shows a typical inlet mixer assembly.

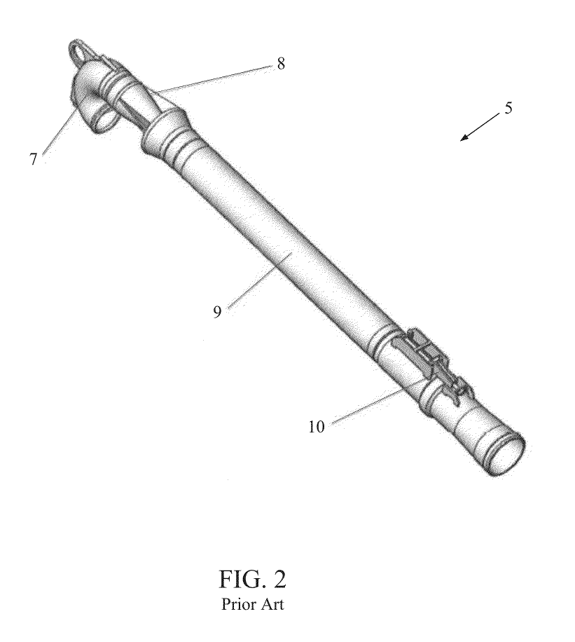

FIG. 3 shows two slip joint seals of the present invention in place on a jet pump assembly.

FIG. 4 shows one component of the slip joint seal of FIG. 3.

FIG. 5 shows a first view of a connection of the seal components of the seal of FIG. 3.

FIG. 6 shows a second view of a connection of the seal components of the seal of FIG. 3.

FIG. 7 shows a third view of a connection of the seal components of the seal of FIG. 3.

FIG. 8 shows a partial cross-sectional view of the seal of FIG. 3.

FIG. 9 shows another slip joint seal of the present invention in place on a jet pump assembly.

FIG. 10 shows a partial close-up view of one component of the slip joint seal of FIG. 9.

### DETAILED DESCRIPTION OF THE INVENTION

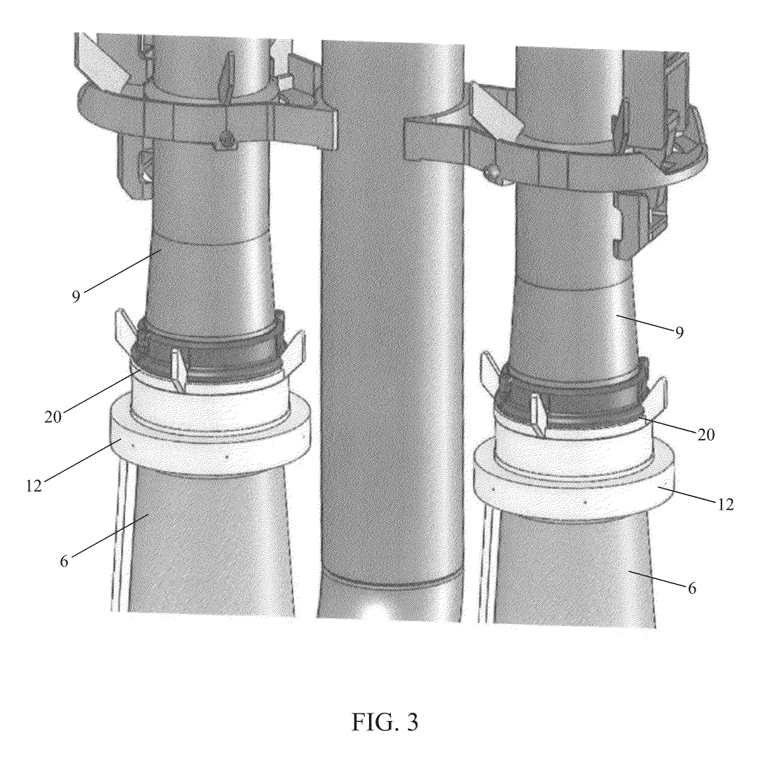

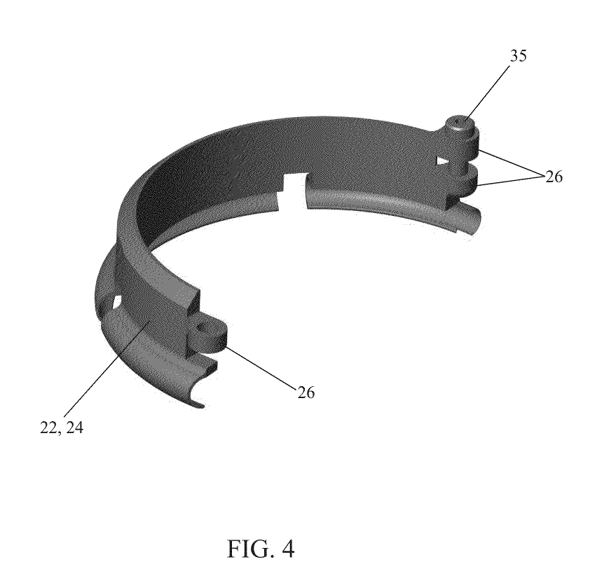

FIG. 3 shows two slip joint seals 20 of the present invention in place on a jet pump assembly. The seal 20 includes two components or halves 22, 24. FIG. 4 shows an exemplary view of one of the seal halves 22, 24. In a preferred embodiment, the seal components 22, 24 are substantially identical. Each seal component 22, 24 has an arcuate profile that covers approximately 180° about a central axis of rotation. Flanges 26 are positioned on circumferential ends thereof. Preferably, two such flanges 26 are positioned on a first end of the seal component 22, 24 and one such flange 26 on a second end of the seal component 22, 24. The flanges 26 are sized and positioned such that they matingly correspond and intermingle with the flanges 26 of the other seal component 24, 22 when placed in the use position.

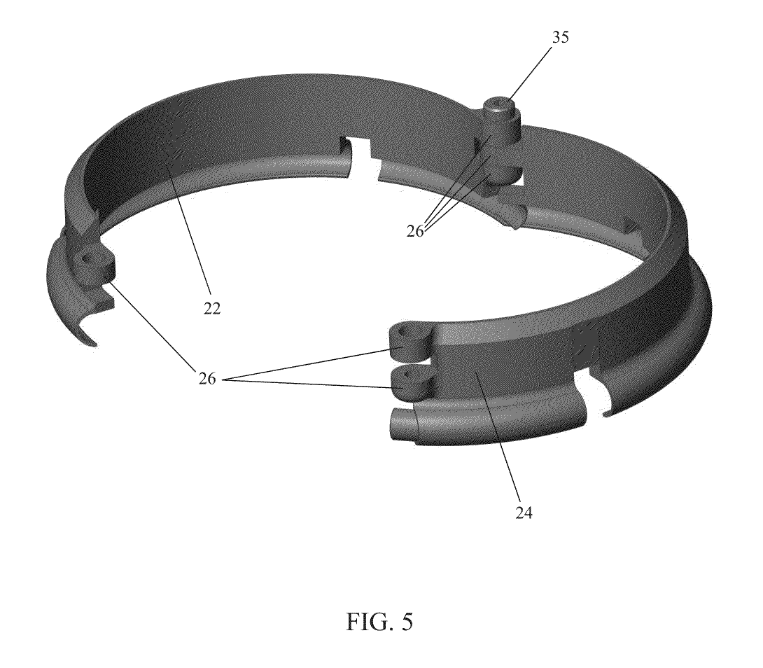

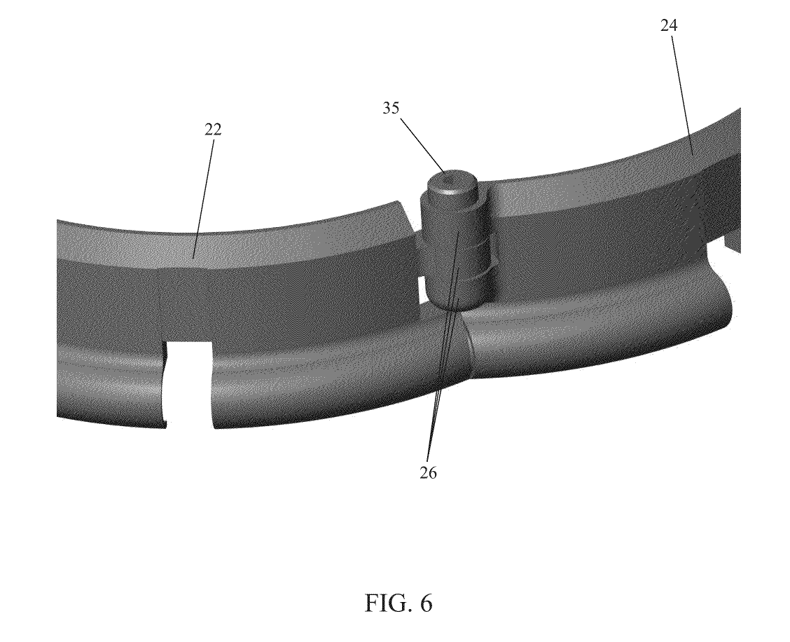

FIGS. 5 and 6 illustrate how the ends of the seal components 22, 24 are connected in a preferred embodiment. The seal components 22, 24 are positioned with the lone flange 26 of one seal component 22 positioned within the two flanges 26 of the other seal component 24. The seal components 22, 24 are arranged such that the intermingled flanges 26 of the components 22, 24 are substantially aligned, defining a receptacle into which a fastener 35 can be positioned to join the ends of the seal components 22, 24. The fastener 35 can take a variety of forms, one preferred form being a bolt formed of XM-19. The inner surfaces of one or more of the flanges 26 can be threaded to correspond with the bolt threading, or a separate nut can be provided. Preferably, the fasteners 35 include a locking mechanism such as ratcheting or a crimp cup to lock them in position once they are installed. Thus, the fasteners 35 will not unintentionally become loose or separate from the seal components 22, 24.

With one set of seal ends connected as illustrated in FIGS. 5 and 6, the other set of ends are open to allow the seal 20 to be positioned around the mixer body 9 of the jet pump 1. The seal is the closed and a second fastener 35 positioned within the intermingled flanges 26 of the second set of ends. The closed seal 20 is then seated atop the diffuser collar assembly 6.

The seal components 22, 24 may be formed of a shape memory alloy (SMA) such as a nickel titanium (NiTi) alloy. Once formed, SMA materials can be bent or stretched and will hold those shapes until heated above a transition temperature. Upon heating, the shape changes back to its original configuration. Each seal component 22, 24 is formed and/or machined in known manner to have an inner surface diameter that corresponds with the outer surface of the jet pump mixer 9. Once formed, the seal components 22, 24 are stretched such as with a mandrel arrangement to plastically deform the components 22, 24 to enlarge the diameters and provide clearance for installation about the mixer 9. Once the seal components are connected and placed in the use position as described above, the seal 20 is heated to restore the seal components 22, 24 to their original shape. This causes the seal diameter to shrink, tightly clamping the seal 20 to the mixer 9 as illustrated in FIG. 3. The seal 20 can be heated in known manner, such as by the application of hot water.

The seal 20 prevents jet pump vibration by restricting the flow path in the slip joint 12, which has been shown to cause flow induced vibration. The seal 20 clamps to the mixer assembly 9 adjacent the slip joint 12 and provides a seal to the slip joint 12 by sitting atop of the diffuser 6.

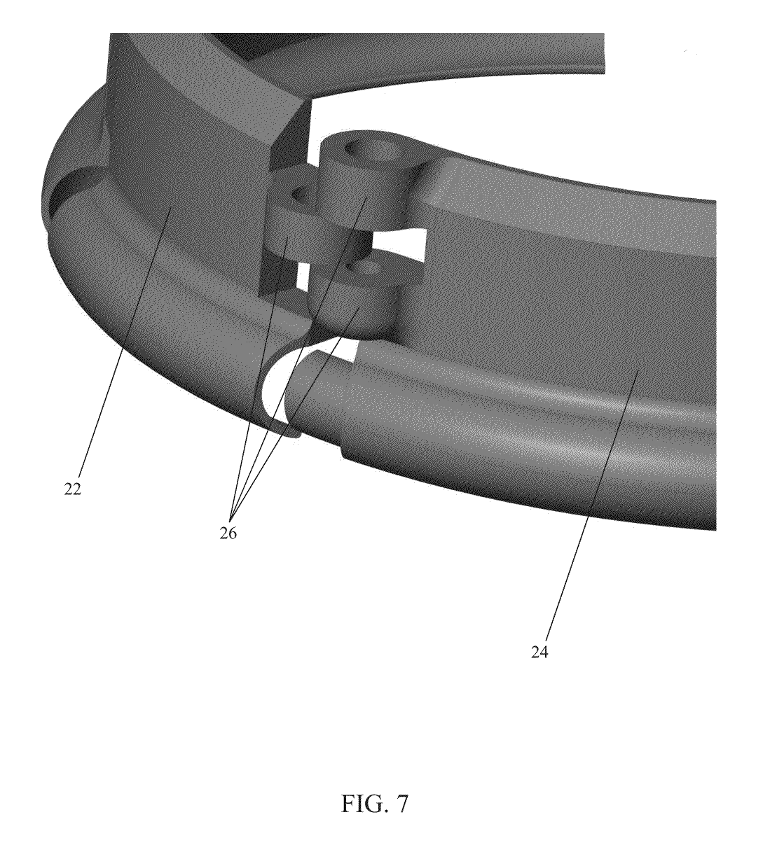

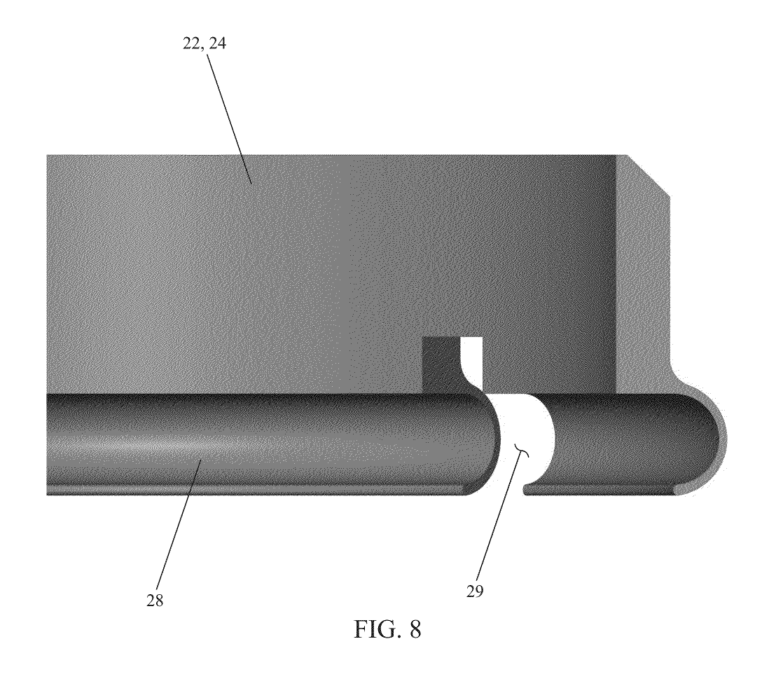

FIG. 8 shows a partial cross-sectional view of the seal components 22, 24. A curved flexure geometry 28 is provided on a bottom of the seal 20. The flexure 28 compensates or flexes to allow the diffuser 6 to grow thermally without overstressing the seal 20 material. Thus, the seal is improved as the jet pump assembly 1 heats up, which causes the diffuser 6 to move towards the collar thereby increasing the load on the flexure geometry on the collar. As shown in FIG. 7, overlap may be provided in the flexure geometries of corresponding seal components 22, 24. The seal 20 may also have notches 29 that fit around the fins of the diffuser collar 6. The notches 29 have enough clearance to allow for the mixer 9 to be offset from the diffuser 6. The notches may include sealing members such as metal gaskets to prevent leakage.

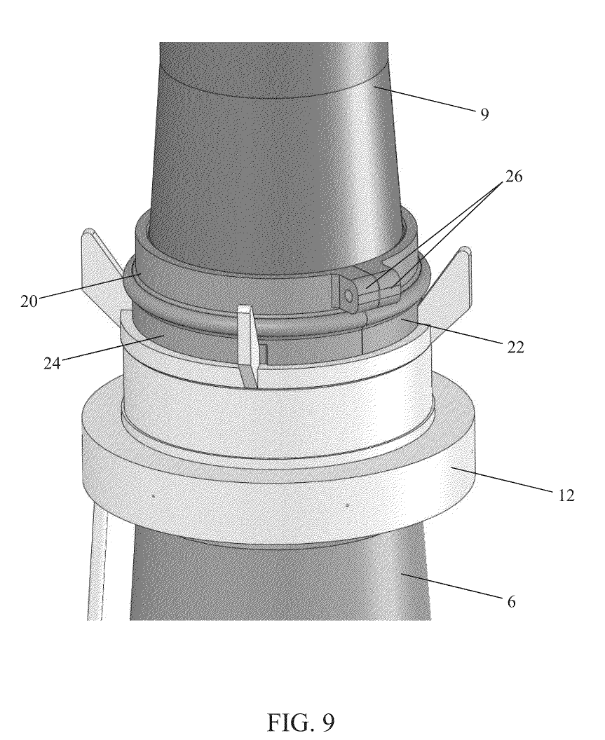

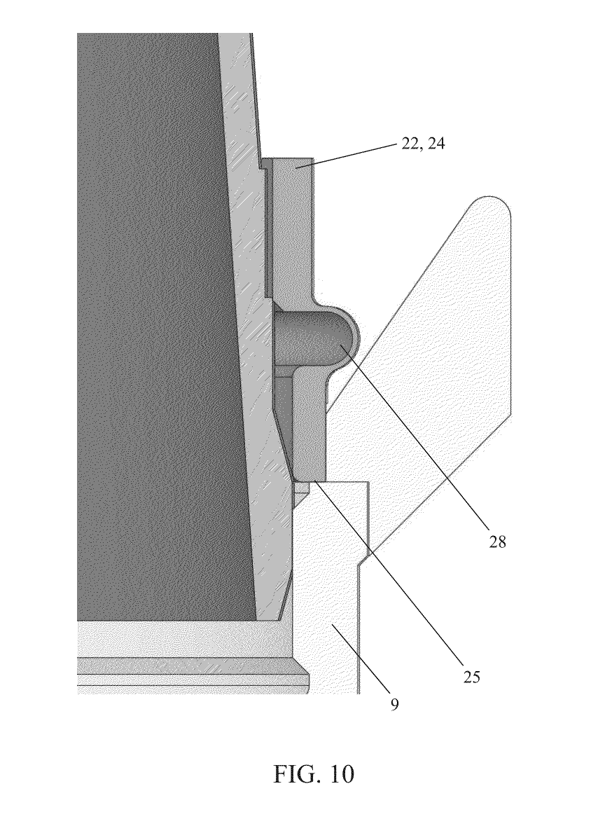

FIGS. 9 and 10 illustrate another slip joint seal 20 of the present invention. In this embodiment, the seal 20 is designed to encircle the mixer 9 just above and adjacent the diffuser 6. The flexure portion 28 is above the diffuser fins, and thus no notches are required for this embodiment. Here, the flexure portion 28 is located in a middle position such that the seal 20 includes a lower edge or surface 25 that is configured to abut the diffuser 6.

FIGS. 9 and 10 also illustrate the stainless steel embodiment of the seal 20. Each seal component 22, 24 includes a flange 26 at circumferential ends thereof. When the seal halves 22, 24 are arranged, the flanges 26 cooperate to define a receptacle into which a fastener 35 can be positioned to join the ends of the seal components 22, 24 and to secure the clamp 20 to the mixer assembly 5. Here, the receptacles are substantially coplanar or parallel to the plane of the seal 20, whereas the receptacles in the embodiment illustrated in FIGS. 3-7 are substantially perpendicular to the plane of the seal 20.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

What is claimed is:

1. A method of providing a leakage barrier in a jet pump assembly having a mixer connected to a diffuser by a slip joint, comprising:
providing a first curved seal component having a first shape and a second curved seal component having a second shape, said first and second seal components having cooperating flexure geometries;
positioning said seal components around the mixer and adjacent the diffuser;
connecting said seal components to form a continuous loop about the mixer.

2. The method of claim 1, wherein said providing includes providing first and second curved seal components having cooperating flexure geometries along perimeter edges thereof

3. The method of claim 1, wherein said positioning includes positioning said seal components around the mixer such that said flexure geometries are adjacent the diffuser.

4. The method of claim 1, wherein said positioning includes positioning said seal components around the mixer such that a tower edge of said seal components abuts the diffuser and said flexure geometries are spaced from said lower edge.

5. The method of claim 1, wherein said providing includes providing said first and second seal components formed of stainless steel.

6. A method of providing a leakage barrier in a jet pump assembly having a mixer connected to a diffuser by a slip joint, comprising:
providing a first curved seal component having a first shape and a second curved seal component having a second shape, said seal components being formed of a shape memory alloy;
plastically deforming said seal components to increase the sizes thereof;
positioning said seal components around the mixer;
connecting said seal components to form a continuous loop about the mixer; and
applying heat to said seal components to return said first seal component to said first shape and said second seal component to said second shape.

7. The method of claim 6, wherein:
said providing includes providing said first seal component defining a first radius of curvature and providing said second seal component defining a second radius of curvature; and
said deforming includes stretching said first seal component to define a third radius of curvature and stretching said second seal component to define a fourth radius of curvature, said third radius of curvature being greater than said first radius of curvature and said fourth radius of curvature being greater than said second radius of curvature.

8. The method of claim 6, wherein said positioning includes positioning said seal components about the mixer adjacent the slip joint.

9. The method of claim 6, wherein said providing includes providing said first and second seal components formed of a nickel titanium alloy.

10. The method of claim 6, wherein said providing includes providing said first and second seal components that are substantially identical.

11. The method of claim 6, wherein:
said providing includes providing first and second seal components having flanges thereon;
said positioning includes aligning flanges of said first seal component with flanges of said second seal component; and
said connecting includes inserting fasteners within receptacles formed by cooperating first and second seal flanges.

12. The method of claim 11, wherein said providing further includes providing flanges that are positioned on circumferential ends of said seal components.

13. The method of claim 6, wherein:
said providing includes providing first and second seal components having cooperating flexure geometries along perimeter edges thereof; and
said positioning includes positioning said flexure geometries adjacent the diffuser.

14. The method of claim 13, wherein said providing further includes providing notches within said flexure geometries, said notches configured to correspond to fins of the diffuser.
